(19) United States
(12) Patent Application Publication
(10) Pub. No.: US 2013/0299432 A1
(43) Pub. Date: Nov. 14, 2013

(54) Sulfate Scale Control In Low PH Aqueous Systems

(71) Applicant: HERCULES INCORPORATED, Wilmington (DE)

(72) Inventors: Sachin Borkar, Wilmington (DE); Michael James Bluemle, Wilmington (DE); Lawrence J. Andermann, JR., Wilmington (DE)

(21) Appl. No.: 13/889,710

(22) Filed: May 8, 2013

Related U.S. Application Data
(60) Provisional application No. 61/644,529, filed on May 9, 2012.

(51) Int. Cl. C02F 5/14

(52) U.S. Cl. CPC C02F 5/14; C02F 5/145
USPC 210/697; 210/699; 210/700; 562/8; 252/181; 562/20; 562/12; 562/14; 252/180

(57) ABSTRACT

Scale control agents comprising organic phosphonates, either alone or in mixtures with inorganic phosphonates and also optionally polymers, such as low molecular weight polymeric dispersants. The scale control agents may be applied to inhibit scale formation or deposition in highly acidic aqueous systems by adding these agents to such systems in amounts effective to inhibit metal sulfate scale formation.

### CROSS-REFERENCE TO RELATED APPLICATIONS

This application claims the benefit of U.S. Patent Application No. 61/644,529 filed May 9, 2012. U.S. Patent Application No. 61/644,529 is incorporated herein in its entirety by reference.

### BACKGROUND OF THE INVENTION

1. Field of the Invention

The invention relates to inhibition of hard, adherent deposit formation of insoluble metal salts particularly sulfates of metals such as calcium, and/or other alkaline earth metals, in presence of late transition metals in low pH aqueous systems, i.e. highly acidic aqueous systems. In particular organic phosphonates are used, either alone or with inorganic phosphonates and/or polymeric dispersants for scale control in aqueous systems.

The Related Art

Increased maintenance costs, decreased plant throughput, equipment downtime and safety are a few problems associated with scale deposition in industrial processes. The deposition and accumulation of inorganic salts on surfaces, due to changes in temperature, pressure, or pH, lowers equipment efficiency and facilitates corrosive processes. In many instances, these deposits are hard and need to be removed manually, which creates additional safety concerns and also adds significant cost due to production downtime. In recent years, there has been an increasing demand for chemicals to remove soluble salts, suppress precipitation or alter the crystal morphology to avoid deposition.

Certain organic and inorganic phosphonates have been used, either alone or with polymers, as scale control or inhibition agents but the effectiveness of such phosphonates is limited to systems having pH above 4 or 5. Additionally, low molecular weight polymeric scale control agents, including those bearing carboxylic acid or sulfonic acid functionality, typically perform very poorly in low pH systems which can be attributed to the low dissociation constants (pKa) of such polymers. Because conventional scale control agents have operational limits with respect to pH, phosphonate based agents including those comprising phosphonate and polymer, for use in highly acidic systems, such as those having pH less than about 4, to suppress scale deposition, including by threshold inhibition or crystal habit modification, are highly desired. Such scale control agents would be useful in mining applications which involve wide ranges of pH, temperature, and pressure depending on the type of ore subjected to mineral processing.

### SUMMARY OF THE INVENTION

The scale control agents comprising organic phosphonates are applied to inhibit hard, adherent deposit formation of insoluble metal salts particularly sulfates of metals such as calcium, and/or other alkaline earth metals in presence of late transition metals. These agents may be applied on filter presses, weeping lines for heap leaches, pipes, holding vessels, evaporators, heat exchangers, cooling towers, boilers, autoclaves, or other sites that induce scale deposit formation in industrial processes.

The scale control agents comprise organic phosphonates, either alone or in combination with inorganic phosphonates and/or polymeric dispersants. Organic phosphonates having alkyl amine spacers may be used, such as those having 5 or more phosphonate groups between alkyl spacers. The scale control agent may further comprise polymers, such as low molecular weight polymeric dispersants. These additives are effective at scale control, such as inhibiting metal sulfate nucleation in highly acidic aqueous systems that may also have high concentrations of hardness, chloride, sulfate, organics, dissolved transition metals or corrosion inhibitors or insoluble solids or operate at high temperature, and pressure. These agents suppress calcium sulfate deposition through threshold inhibition and also by altering crystal morphology. The invention also concerns processes for inhibiting and/or removing scale from the surface of a substrate, such as process equipment, comprising adding the scale control agent to a highly acidic aqueous system in an effective amount to inhibit scale formation or deposition on a surface in contact with the highly acidic aqueous system. As used in this specification the term “low pH aqueous systems” or “highly acidic aqueous systems” means those aqueous systems having pH less than about 4, including less that about 3, less that about 2 or less than about 1; including all points within these specified ranges.

All parts and percentages set forth in this specification and the appended claims are on a weight by weight basis unless otherwise specified.

### DESCRIPTION OF THE DRAWINGS

FIG. 1 is a graph showing the effect of water hardness on bis(hexamethylenetriaminepenta (methylenephosphonic acid) BHMTAP performance.

FIG. 2 is a scanning electron microscope image of calcium sulfate crystal morphology with no additive treatment.

FIG. 3 is a scanning electron microscope image of calcium sulfate crystal morphology treated with 100 parts per million (ppm) BHMTAP in accordance with an embodiment of the invention.

FIG. 4 is a scanning electron microscope image of calcium sulfate crystal morphology treated with 50 ppm of scale control agent in accordance with an embodiment of the invention comprising KEMGUARD® 269 polymer (available from Kemira, Helsinki, Finland) and BHMTAP (Additive C).

FIG. 5 is a scanning electron microscope image of calcium sulfate crystal morphology treated with 50 ppm of scale control agent in accordance with an embodiment of the invention comprising polymer of acrylic acid/maleic acid (poly(AA/MA)) and BHMTAP (Additive A).

### DETAILED DESCRIPTION OF THE INVENTION

The invention relates to organic phosphonates for scale inhibition in highly acidic aqueous systems, such as process waters having soluble transition metals, high concentrations of hardness, sulfates, chlorides, organics, and salts. Typically the scale control agents comprise organic phosphonates and polymer, and may optionally comprise inorganic phosphonate. The invention further relates to processes for the inhibition of and/or removal of scale deposits, such as calcium sulfate scale, comprising adding the scale control agent to a highly acidic system, for example a system having a pH of about 3 or less, in an effective amount to inhibit the formation of scale on a surface in contact with the highly acidic aqueous system. Typically, the organic phosphonate is added to the highly acidic system in amounts of about 5 parts per million (ppm) to about 200 ppm, such as about 5 ppm to about 100 ppm, preferably about 10 ppm to about 50 ppm and may be added in amounts of about 5 ppm to about 25 ppm.

Organic phosphonates useful in the scale control agent include bis(hexamethylenetriaminepenta (methylenephosphonic acid) (BHMTAP), diethylenetriaminepentakis(methylphosphonic acid) (DETPMPA), hexamethylene diamine tetra(methylene phosphonic acid) (HMDTMPA), polyamino polyether methylene phosphonate (PAPEMP), 1-hydroxy ethylidene-1,1-diphosphonic acid (HEDP), nitrilo(methylphosphonic acid) (ATMP), etidronic acid or phosphino carboxylic acid (PCA) and mixtures thereof. The low molecular weight polymeric dispersant typically comprises polymers derived from unsaturated monomers bearing one or more of the following functionalities: carboxylic acid, sulfonic acid, phosphonic acid, alcohol or amide, and their respective salts.

### EXAMPLES

### Example 1

Organic phosphonates bearing an alkyl amine spacer were employed alone and in combination with low molecular weight polymeric dispersants to inhibit calcium sulfate scale formation or deposition. The efficacy of organic phosphonates was studied and results are listed in Table 1. The efficacies of phosphonates alone were tested using highly acidic mimic process water having 5,000 ppm of calcium (as CaCO₃), 20,000 ppm of sulfate and 3,700 ppm of chloride ion. Solution A was prepared by dissolving 14.7 g of calcium chloride dihydrate and 0.713 g of anhydrous sodium chloride to a total volume of 1 liter using deionized (DI) water. Solution B was prepared by dissolving 14.306 g of anhydrous sodium sulfate and 31.32 g of concentrated sulfuric acid to a total volume of 1 liter using deionized (“DI”) water. For scale control testing, an appropriate amount of the scale control additive was added to 50 mL of solution A and mixed thoroughly. The pH of the test water was maintained between 0.9-1.1. To this mixture, 50 mL of solution B was added and mixed for 2 hours at the desired temperature. On completion, the solutions were filtered and the filtrate was titrated with 0.2 M EDTA-Na₄ solution using CalVer 2 as indicator to determine the soluble calcium concentration. The results of these tests are summarized in Table 1.

TABLE 1
Effect of organic phosphonates on calcium sulfate scale inhibition

| No. | Additive | Dose, ppm | Temperature, ° C. | % Inhibition |
|---|---|---|---|---|
| 1 | Blank | 0 | 50 | 48 |
| 2 | ATMP | 100 | 50 | 52 |
| 3 | ATMP | 200 | 50 | 56 |
| 4 | DETPMPA | 10 | 50 | 55 |
| 5 | DETPMPA | 25 | 50 | 69 |
| 6 | HMDTMPA | 10 | 50 | 78 |
| 7 | HMDTMPA | 25 | 50 | 99 |
| 8 | BHMTAP | 5 | 50 | 90 |
| 9 | BHMTAP | 10 | 50 | 99 |

Tests performed with no scale control additive resulted in formation of calcium sulfate precipitate. Amino trimethylene phosphonic acid (ATMP) bearing three phosphonic acid groups showed increased inhibition compared to the blank control but had less inhibition than the other tested acids. Diethylenetriaminepentakis (methylphosphonic acid) (DETPMPA) containing five methyl phosphonic acid functionalities separated by ethylene diamine units showed better performance when compared with ATMP and the blank control. Use of phosphonates, hexamethylene diamine tetra (methylene phosphonic acid) (HMDTMPA) and bis(hexamethylenetriaminepenta(methylenephosphonic acid)), (BHMTAP) having six carbon spacer length showed the best performance. While the mechanism of scale inhibition by use of organic phosphonate has not been elucidated, the inventors without wishing to be bound by theory propose the efficacy of organic amino phosphonates is dependent on alkyl spacer length between nitrogen and phosphorus atom and also on number of methyl phosphonic acid groups.

### Example 2

The efficacy of DETPMPA, HMDTMPA and BHMTAP in highly acidic mimic waters containing acidified solution of transition metal sulfates (Al, Cu, Fe, Mn etc) was studied. Solution C was prepared by dissolving 14.7 g of calcium chloride dihydrate and 12.2 g of 1 N hydrochloric acid to a total volume of 1 liter using DI water. Solution D mixed element water was prepared by dissolving metal sulfate of iron sulfate heptahydrate 0.7 g, aluminum sulfate octadecylhydrate 0.33 g, copper sulfate pentahydrate 2.72 g, manganese sulfate monohydrate 0.22 g and 40.32 g of concentrated sulfuric acid to a total volume of 1 liter using DI water. For scale control testing, an appropriate amount of the scale control additive was added to 50 mL of solution C and mixed thoroughly. The pH of the test water was maintained between 0.9-1.1. To this mixture, 50 mL of solution D was added and mixed for 2 hours at the desired temperature. On completion, the solutions were filtered through 45 micron syringe filter and filtrates were analyzed by using inductively coupled plasma-atomic emission spectroscopy (ICP-AES). The threshold inhibition was calculated by using following formula:

$$PercentThreshold Inhibition ( \% Inb . ) = ( [ \frac{{Ca}_{SITU} - {Ca}_{BLK}}{{Ca}_{TOTAL} - {Ca}_{BLK}} ] ) * 100 \%$$

Where, Ca_{SITU} is amount of calcium in filtrate
Ca_{BLK} is amount of calcium measured for filtrate obtained with no additive treatment
Ca_{TOTAL} is amount of calcium in test water

TABLE 2
Effect of phosphonate on scale inhibition using mixed element water and
ICP-AES measurement technique

| No. | Additive | Dose, ppm | Temperature, ° C. | % Inhibition |
|---|---|---|---|---|
| 1 | DETPMPA | 25 | 50 | 10 |
| 2 | DETPMPA | 50 | 50 | 27 |
| 3 | HMDTMPA | 25 | 50 | 17 |
| 4 | HMDTMPA | 100 | 50 | 76 |
| 5 | BHMTAP | 10 | 50 | 82 |
| 6 | BHMTAP | 100 | 50 | 92 |

Table 2 shows, performance of these phosphonates in presence of transition metal sulfates present in mimic water. Under the conditions listed in Table 2, DETPMPA and HMDTMPA experienced an effect in performance when evaluated with mimic waters containing soluble salts of transition metals. Whereas, changing the water chemistry of mimic test water, BHMTAP efficacy did not change significantly.

### Example 3

The effect of temperature on BHMTAP performance was evaluated. Solution E was prepared by dissolving 14.7 g of calcium chloride dihydrate and 0.713 g of anhydrous sodium chloride to a total volume of 1 liter using DI water. Solution F was prepared by dissolving 14.306 g of anhydrous sodium sulfate and 31.32 g of concentrated sulfuric acid to a total volume of 1 liter using DI water. For scale control testing, an appropriate amount of the scale control additive was added to 50 mL of solution E and mixed thoroughly. The pH of the test water was maintained between 0.9-1.1. To this mixture, 50 mL of solution F was added and mixed for 2 hours at the desired temperature. On completion, the solutions were filtered and the filtrate was titrated with 0.2 M EDTA-Na₄ solution using CalVer 2 as indicator to determine the soluble calcium concentration. The results of these tests are summarized in Table 3

TABLE 3
Effect of temperature on BHMTAP performance

| No. | Additive | Dose, ppm | Temperature, ° C. | % Inhibition |
|---|---|---|---|---|
| 1 | Blank | 0 | 25 | 39 |
| 2 | BHMTAP | 5 | 25 | 45 |
| 3 | BHMTAP | 10 | 25 | 79 |
| 4 | BHMTAP | 25 | 25 | 99 |
| 5 | Blank | 0 | 50 | 48 |
| 6 | BHMTAP | 5 | 50 | 90 |
| 7 | BHMTAP | 10 | 50 | 99 |
| 8 | Blank | 0 | 70 | 66 |
| 9 | BHMTAP | 5 | 70 | 90 |
| 10 | BHMTAP | 10 | 70 | 99 |

The solubility of calcium sulfate in water is temperature dependent. The lower the temperature tested under these conditions, the stronger the thermodynamic driving force for precipitation. Thus, increasing amounts of calcium sulfate precipitation were observed with decreasing temperature. When solutions were charged with 10 ppm of additive at 25° C., small amount of precipitate was observed after 2 hours. Similarly, the titrations performed on the filtrate suggested 79% of calcium remained in the solution. Further increase in additive concentration to 25 ppm showed no precipitate formation over 2 hours and titration of filtrate also shows 99% inhibition (Table 3). Further, when a similar experiment was performed at 70° C., the temperature at which calcium sulfate is more soluble than ambient temperature, 10 ppm of BHMTAP additive was sufficient enough to achieve quantitative inhibition over 2 hours.

### Example 4

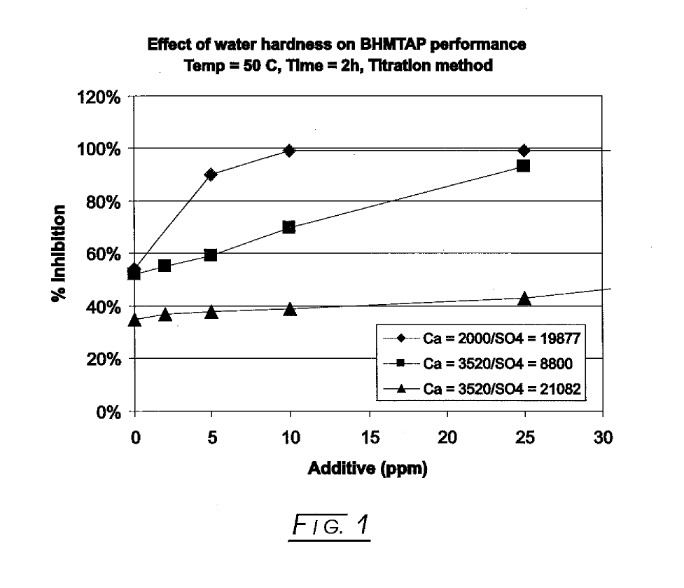

The effect of hardness was studied by varying the calcium ion concentration in water. The concentration of calcium, chloride and sulfate ion in solution G and H were maintained in such a way that on mixing 50 mL of each solution can lead into desired concentration of individual ion and pH in the test water. For scale control testing, an appropriate amount of the scale control additive was added to 50 mL of solution G and mixed thoroughly. To this mixture, 50 mL of solution H was added and mixed for 2 hours at the desired temperature. On completion, the solutions were filtered and the filtrate was titrated with 0.2 M EDTA-Na₄ solution using CalVer 2 as indicator to determine the soluble calcium concentration. The results of these tests are shown in FIG. 1 which shows the plot of BHMTAP concentration as a function of threshold inhibition for water with three different levels of hardness. Increasing calcium ion concentration from 5,000 ppm to 8,800 ppm demands significantly higher dosage of additive to achieve quantitative inhibition. Runs performed using water with increased calcium concentration and lower sulfate concentration also require 25 ppm of additive to reach up to 97% inhibition.

### Example 5

The effect of transition metal ions on BHMTAP performance was studied. Mimic waters with 5,000 ppm calcium as calcium carbonate, 20,000 ppm sulfate, and 7,000 ppm chloride were prepared. Solution J was prepared by dissolving 14.7 g of calcium chloride dihydrate and 0.713 g of anhydrous sodium chloride to a total volume of 1 liter using DI water. Solution K was prepared by dissolving 14.306 g of anhydrous sodium sulfate and 31.32 g of concentrated sulfuric acid to a total volume of 1 liter using DI water. 1% solutions of desired metal sulfate (Al, Cu, Fe, Mn and Zn) were prepared by dissolving respective amount of metal sulfate in 100 mL DI water. For scale control testing, an appropriate amount of the scale control additive (10 ppm) and metal sulfate, solution were added to 50 mL of solution J and mixed thoroughly. The pH of the test water was maintained between 0.9-1.1. To this mixture, 50 mL of solution K was added and mixed for 2 hours at the desired temperature. On completion, the solutions were filtered through 45 micron syringe filter and filtrates were analyzed by using inductively coupled plasma-atomic emission spectroscopy (ICP-AES). The threshold inhibition was calculated by using formula applied in Example 2.

TABLE 4
Effect of metal sulfates on BHMTAP performance at 50° C.

| Expt. 1 | | Expt. 2 | | Expt. 3 | | Expt. 4 | | Expt. 5 | |
|---|---|---|---|---|---|---|---|---|---|
| Al (ppm) | % I | Fe (ppm) | % I | Cu (ppm) | % I | Zn (ppm) | % I | Mn (ppm) | % I |
| 0 | 99 | 0 | 99 | 0 | 99 | 0 | 99 | 0 | 99 |
| 25 | 98 | 100 | 99 | 1000 | 82 | 100 | 99 | 50 | 99 |
| 50 | 96 | 200 | 99 | 1500 | 81 | 250 | 99 | 100 | 99 |
| 100 | 98 | 500 | 39 | | — | 500 | 99 | 200 | 89 |

As shown in table 4, individual solution of metal sulfate salts were added to the mimic water discussed above to obtain a solution with desired concentration of each metal. The amount of additive added for each experiment was maintained as 10 ppm. The data presented in table 4 suggest higher concentrations of iron and copper affect the additive performance. Whereas, aluminum, manganese and zinc did not demonstrate appreciable change in BHMTAP performance.

### Example 6

The performance of low molecular weight polymeric dispersant and BHMTAP blend was evaluated. Low molecular weight polymers derived from one or more than one of the following monomers vinyl sulfonate (SVS), allyl sulfonates (SAS), acrylic acid (AA), vinyl phosphonic acid and maleic acid (MA) or their salts were synthesized. Blends of above mentioned polymers or commercial polymer KEMGUARD® 269 with BHMTAP with three different ratios of 1:3, 1:1 and 3:1 w/w were prepared and their performances were evaluated using mimic process water with 8,800 ppm Ca as CaCO₃, 20,000 ppm sulfate and 7,400 ppm of chloride ion. Solution L was prepared by dissolving 25.1 g of calcium chloride dihydrate and 4.28 g of anhydrous sodium chloride to a total volume of 1 liter using DI water. Solution M was prepared by dissolving 14.31 g of anhydrous sodium sulfate and 31.32 g of concentrated sulfuric acid to a total volume of 1 liter using DI water. For scale control testing, an appropriate amount of the scale control additive was added to 50 mL of solution L and mixed thoroughly. The pH of the test water was maintained between 0.9-1.1. To this mixture, 50 mL of solution M was added and mixed for 2 hours at the desired temperature (50° C.), on completion the solutions were filtered and the filtrate was titrated with 0.2 M EDTA-Na₄ solution using CalVer 2 as indicator to determine the soluble calcium concentration. The results of these tests are summarized in table 5.

TABLE 5
Effect of low molecular weight polymer dispersant and BHMTAP blend

| No. | Additive | Dose, ppm | % Inhibition |
|---|---|---|---|
| 1 | | 0 | 40% |
| 2 | BHMTAP | 2 | 42% |
| 3 | BHMTAP | 5 | 44% |
| 4 | BHMTAP | 10 | 49% |
| 5 | BHMTAP | 25 | 58% |
| 6 | BHMTAP | 50 | 82% |
| 7 | Additive A | 2 | 41% |
| 8 | Additive A | 5 | 43% |
| 9 | Additive A | 10 | 44% |
| 10 | Additive A | 25 | 51% |
| 11 | Additive A | 50 | 68% |
| 12 | Additive B | 2 | 41% |
| 13 | Additive B | 5 | 42% |
| 14 | Additive B | 10 | 44% |
| 15 | Additive B | 25 | 53% |
| 16 | Additive B | 50 | 68% |
| 17 | Additive C | 2 | 41% |
| 18 | Additive C | 5 | 43% |
| 19 | Additive C | 10 | 44% |
| 20 | Additive C | 25 | 56% |
| 21 | Additive C | 50 | 83% |

Additive A = poly(AA/MA) + BHMTAP (1:3 w/w),
Additive B = poly(SVS) + BHMTAP (1:3 w/w) and
Additive C = KEMGUARD ® 269 (from Kemira) + BHMTAP (1:3 w/w)

### Example 7

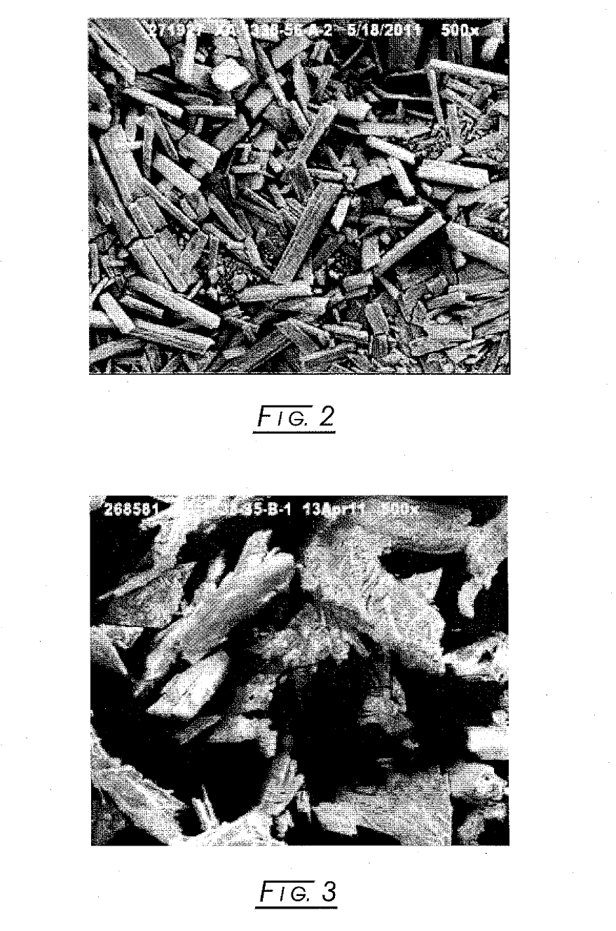

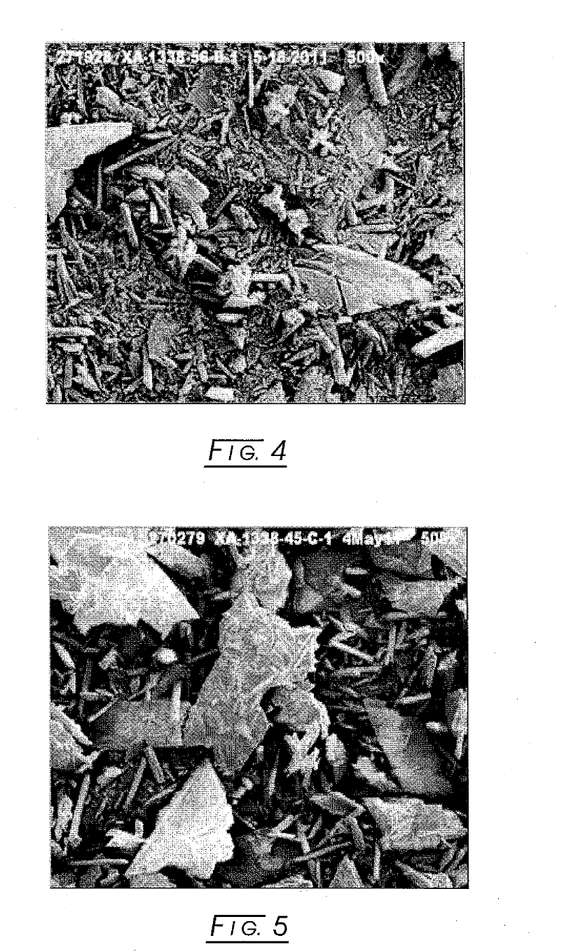

The effect of BHMTAP and its blends with polymeric dispersants as crystal habit modifier was studied by forcing scale formation with and without additive treatment. Scale formation with additive treatment was enhanced by using mimic water with mixed transition elements and by extending the experimental time. The crystal morphology of the obtained scale was observed under scanning electron microscope and the images are shown in FIGS. 2-5. The scale obtained for the blank experiment (without any additive treatment) showed rod-shaped crystals (FIG. 2), whereas scale obtained with 100 ppm BHMTAP treatment showed significant change in crystal morphology (FIG. 3). Similarly, the scale obtained using 50 ppm of Additive C of Example 6 (1:3 w/w blend of KEMGUARD® 269 and BHMTAP) (FIG. 4) or Additive A of Example 6 (poly(AA/MA) and BHMTAP) (FIG. 5) showed smaller crystals. This sludge like scale is less prone to accumulate and adhere on surface or to form deposits.

The scanning electron microscope observations can be further supported by particle size and aspect ratio measurement data shown in table 6. This data further suggests with increasing BHMTAP dosage the minimum particle size of the gypsum decreases.

TABLE 6
Morphologi G3i measurements on calcium sulfate scale
obtained with BHMTAP treatment

| | | | 50 ppm |
|---|---|---|---|
| | Blank | 5 ppm BHMTAP | BHMTAP |
| Length minimum (μm) | 6.74 | 6.11 | 6.09 |
| Length Maximum (μm) | 681.57 | 830.42 | 905.52 |
| Length Mean (μm) | 54.7 | 46.54 | 41.75 |
| 90% particles are < (μm) | 116.38 | 103.69 | 99.50 |
| Mean aspect ratio | 0.352 | 0.442 | 0.508 |

What is claimed is:

1. Scale control agents for inhibiting scale formation or deposition in highly acidic aqueous systems comprising organic phosphonates.

2. The scale control agents of claim 1 further comprising inorganic phosphonates.

3. The scale control agents of claim 1 wherein the highly acidic aqueous system has a pH less than about 4.

4. The scale control agents of claim 1 wherein the organic phosphonate has 5 or more phosphonate groups between alkyl spacers.

5. The scale control agent of claim 1 wherein the organic phosphonate is selected from the group consisting of bis(hexamethylenetriaminepenta (methylenephosphonic acid) (BHMTAP), diethylenetriaminepentakis(methylphosphonic acid) (DETPMPA), hexamethylene diamine tetra(methylene phosphonic acid) (HMDTMPA), polyamino polyether methylene phosphonate (PAPEMP), 1-hydroxy ethylidene-1,1-diphosphonic acid (HEDP), nitrilo(methylphosphonic acid) (ATMP), etidronic acid, phosphino carboxylic acid (PCA) and combinations thereof.

6. The scale control agents of claim 1 further comprising polymer.

7. The scale control agents of claim 6 wherein the polymer is a low molecular weight polymeric dispersant.

8. The scale control agent of claim 7 wherein the polymer comprises one or more than one functionality selected from the group consisting of carboxylic acid, sulfonic acid, phosphonic acid, alcohol, amide and salts thereof.

9. A process for inhibiting or preventing the formation of scale on a substrate having at least one surface in contact with a highly acidic aqueous system comprising adding the scale control additive of claim 1 to the highly acidic aqueous system in an effective amount to inhibit the formation of scale on the surface.

10. The process of claim 9 wherein the highly acidic aqueous system has a pH less than about 4.

11. The process of claim 9 wherein the scale comprises calcium.

12. The process of claim 9 wherein the organic phosphonate has 5 or more phosphonate groups between alkyl spacers.

13. The process of claim 9 wherein the organic phosphonate is selected from the group consisting of bis(hexamethylenetriaminepenta (methylenephosphonic acid) (BHMTAP), diethylenetriaminepentakis(methylphosphonic acid) (DETPMPA), hexamethylene diamine tetra(methylene phosphonic acid) (HMDTMPA), polyamino polyether methylene phosphonate (PAPEMP), 1-hydroxy ethylidene-1,1-diphosphonic acid (HEDP), nitrilo(methylphosphonic acid) (ATMP), etidronic acid, phosphino carboxylic acid (PCA) and combinations thereof.

14. The process of claim 9 wherein the scale control agent further comprises inorganic phosphonate.

15. The process of claim 9 wherein the scale control agent further comprises polymer.

16. The process of claim 15 wherein the polymer is a low molecular weight polymeric dispersant.

17. The process of claim 15 wherein the polymer comprises a functionality selected from the group consisting of carboxylic acid, sulfonic acid, alcohol, amide and salts thereof.
